(19) United States
(12) Patent Application Publication
(10) Pub. No.: US 2010/0289428 A1
(43) Pub. Date: Nov. 18, 2010

(54) Controllable Retroffited LED Panel Lighting

(75) Inventors: Joseph E. Frazier, Lebanon, IN (US); Kevin J. Shelow, Indianapolis, IN (US); Gary D. Colip, Noblesville, IN (US)

Correspondence Address: BAKER & DANIELS LLP, 300 NORTH MERIDIAN STREET, SUITE 2700, INDIANAPOLIS, IN, 46204, US

(73) Assignee: Advanced Control Technologies, Inc., Indianapolis, IN (US)

(21) Appl. No.: 12/777,915

(22) Filed: May 11, 2010

Related U.S. Application Data
(63) Continuation-in-part of application No. 12/683,822, filed on Jan. 7, 2010.
(60) Provisional application No. 61/177,332, filed on May 12, 2009.

(51) Int. Cl. H05B 37/02; B23P 23/00

(52) U.S. Cl. 315/294; 29/401.1

(57) ABSTRACT

The present invention involves a lighting kit adapted for installation into a conventional fluorescent lighting unit having a fluorescent socket and a ballast disposed in the lighting unit. At least one elongated body has fixture ends configured to engage a fluorescent socket. The elongated body supports a plurality of light emitting diodes (LEDs). A control unit, capable of receiving exterior control signals, electrically connects the LEDs to a power source for selectively dimming the LEDs, and is adapted to be mounted in place of the ballast. Dimming may be accomplished by control circuitry that recognizes repeated switching of a power source, and/or by a dipswitch on the LED device that sets the dim level. A method of retrofitting a fluorescent housing unit involves installing a LED device in the fluorescent housing unit and mounting an LED driver in the location configured to receive a conventional fluorescent ballast.

### RELATED APPLICATIONS

This application claims the benefit of U.S. Provisional Patent Application Nos. 61/143,043 and 61/177,332, and U.S. patent application Ser. No. 12/683,822, the disclosures of which are expressly incorporated by reference herein.

### BACKGROUND OF THE INVENTION

1. Field of the Invention

The present invention relates to industrial and residential lighting. More specifically, the present invention relates to such lighting systems utilizing light emitting diodes (LEDs).

2. Description of the Related Art

Light Emitting Diode (LED) lights provide advantages to commercial and residential applications because of their low power consumption. As production has increased, the cost of LED lights has made these lights more attractive. However, LED lights are often incompatible with the lighting infrastructure of the typical home or industrial setting. The growing emphasis on power reduction for energy savings has created a need for more efficient applications of the LED light technology.

### SUMMARY OF THE INVENTION

In one exemplary embodiment, the present invention involves an LED retrofit system that replaces one or more ballasts and fluorescent tubes in standard drop ceiling fluorescent lighting fixtures. In one embodiment, the system provides a large mounting area for an LED array comprised of LED panels to thereby allow a high overall LED count. The high LED count results in light output that is competitive with the light output of existing fluorescent lamps while providing the efficiencies of LEDs. In another embodiment, LED tubes are used in a conventional fluorescent fixture. In still a further embodiment, the dimension of the conventional fluorescent fixture is replaced by a LED panel system. Control of the LED panels is accomplished using a control system operating according to a 0-10V control signal.

In one embodiment, the LED configurations are designed to replace fluorescent tubes in commercial and industrial spaces. In one embodiment, the LED circuit is controllable to give the building or home owner more energy efficiency and control in lighting his space. Some implementations have attempted to use TRIAC (triode for alternating current) based dimmers to control the LEDs of existing LED tubes. However, difficulties arose in these implementations as the TRIAC signal did not control or dim the LEDs as expected. In one exemplary embodiment, the LED driver in the LED tube is replaced or eliminated entirely. Further, control circuitry is installed in the location traditionally occupied by the fluorescent lighting ballast. As such, the existing ballast in the fixture is replaced with an LED controller. The LED controller includes a driver for the LEDs based on factors such as the length of the LED tubes, the number of tubes per fixture, and the voltage supply. The LED controller may also include a signal conditioner which may be designed to accept a multitude of different control signals to allow a building automation system (BAS) or lighting system to schedule ON and OFF times, dim the lights based on schedules, dim the lights based on local light or occupancy sensors, and allow for local overrides using RF, powerline or a regular wall switch or dimmer. In one embodiment, a LED panel is used in place of the LED tube. The LED panel may be mechanically mounted in the fluorescent tube sockets to secure their position, while separately electrically connecting the driver to the LED panel.

In one exemplary embodiment, a mounting bracket having similar dimensions as a LED tube is configured to engage the existing fluorescent electric sockets. The mounting bracket may be round like a LED tube or may be round on one side and flat on the other (half moon or “D” shaped). Bi-pin connectors on either side of the mounting bracket engage the electric sockets. In one embodiment, no electrical connection is made between the bi-pin connectors and the electric sockets. As such, the electrical connection from the electric socket, or “tombstone connector”, that the bi-pin connector inserts into is removed. As such, the mounting bracket may be secured into existing fixtures. LED panels of a rectangular, square, or other suitable shape attach to the mounting brackets. Wires from the LED panels may be electrically connected to either line current (with any ballast removed) or to a LED driver circuit. In one embodiment, an existing diffuser or cover on conventional fluorescent fixtures is used to aid light distribution. In one embodiment, the mounting bracket includes the LED panel, obviating the step of attaching the LED panel to the mounting bracket.

In another exemplary embodiment, the LED panel system replaces the fluorescent ballasts, fluorescent tubes, and light diffuser assembly in a standard drop ceiling “troffer” fluorescent lighting fixture. The LED panel system may also mount directly in the drop ceiling opening negating the need for any of the components of the fluorescent lighting fixture. This embodiment provides a large mounting area for the LED array thereby allowing high overall LED count which results in light output that is competitive with the light output of existing fluorescent lamps. The retrofit/complete fixture design may allow common parts to be manufactured in bulk thereby reducing part cost.

The embodiments may also provide for enhanced dimming control. In one embodiment, dimming is set by setting a dipswitch on the LED device to designate a predetermined dimming level. In another embodiment, the control circuitry is programmed to recognize the repeated switching of a power source as an indication of the level of dimming desired.

In one embodiment of the present disclosure, a lighting unit comprises at least one elongated body supporting a plurality of light emitting diodes (LEDs) and a control unit electrically connected to the elongated body, the control unit configured to receive control information signals and provide control commands to the LEDs. The body may include a mounting bracket capable of attachment to an LED panel. The body may be generally cylindrical having an elongate flat section. The control unit may be capable of receiving the control signals over a wireless transmission. The control unit may include means for selectively dimming The LEDs.

In one embodiment of the present disclosure, a method of retrofitting a fluorescent housing unit is provided. The method comprises the steps of installing a LED device in the fluorescent housing unit and mounting an LED driver in the location configured for receiving a conventional fluorescent ballast.

In one embodiment of the present disclosure, a method of retrofitting a fluorescent housing unit is provided. The method comprises the steps of installing a mounting bracket in the fluorescent housing unit, attaching a plurality of LEDs to the mounting bracket, and mounting an LED driver in the location configured for receiving a conventional fluorescent ballast.

### BRIEF DESCRIPTION OF THE DRAWINGS

The above mentioned and other features and objects of this invention, and the manner of attaining them, will become more apparent and the invention itself will be better understood by reference to the following description of an embodiment of the invention taken in conjunction with the accompanying drawings, wherein:

FIG. 1 is a representative view of an exemplary LED lighting system according to one embodiment;

FIG. 2 is a bottom plan view of one embodiment of the LED lighting system of FIG. 1;

FIG. 3 is a bottom plan view of a controller of FIGS. 1 and 2;

FIG. 4 is a representative view of one embodiment of the LED lighting system of FIG. 1;

FIG. 5 is a detailed partial view of a portion of the LED lighting system of FIG. 4;

FIG. 6 is a perspective view of an LED panel of the LED lighting system of FIG. 4;

FIG. 7 is a perspective view of an exemplary tube bracket of the LED lighting system of FIG. 4;

FIG. 7a is a perspective view of another exemplary tube bracket of the LED lighting system of FIG. 4;

FIG. 8 is a perspective view of an end cap of the tube bracket of FIGS. 7 and 7a;

FIG. 9 is a perspective view of a push-in fastener of the LED lighting system of FIG. 4;

FIG. 10 is a perspective view of an exemplary LED lighting system according to one embodiment; and

FIG. 11 is an exploded view of an aspect of the LED lighting system of FIG. 10.

Corresponding reference characters indicate corresponding parts throughout the several views. Although the drawings represent embodiments of the present invention, the drawings are not necessarily to scale and certain features may be exaggerated in order to better illustrate and explain the present invention. The exemplification set out herein illustrates an embodiment of the invention, in one form, and such exemplifications are not to be construed as limiting the scope of the invention in any manner.

### DETAILED DESCRIPTION OF THE DRAWINGS

The embodiments disclosed below are not intended to be exhaustive or limit the invention to the precise form disclosed in the following detailed description. Rather, the embodiment is chosen and described so that others skilled in the art may utilize its teachings.

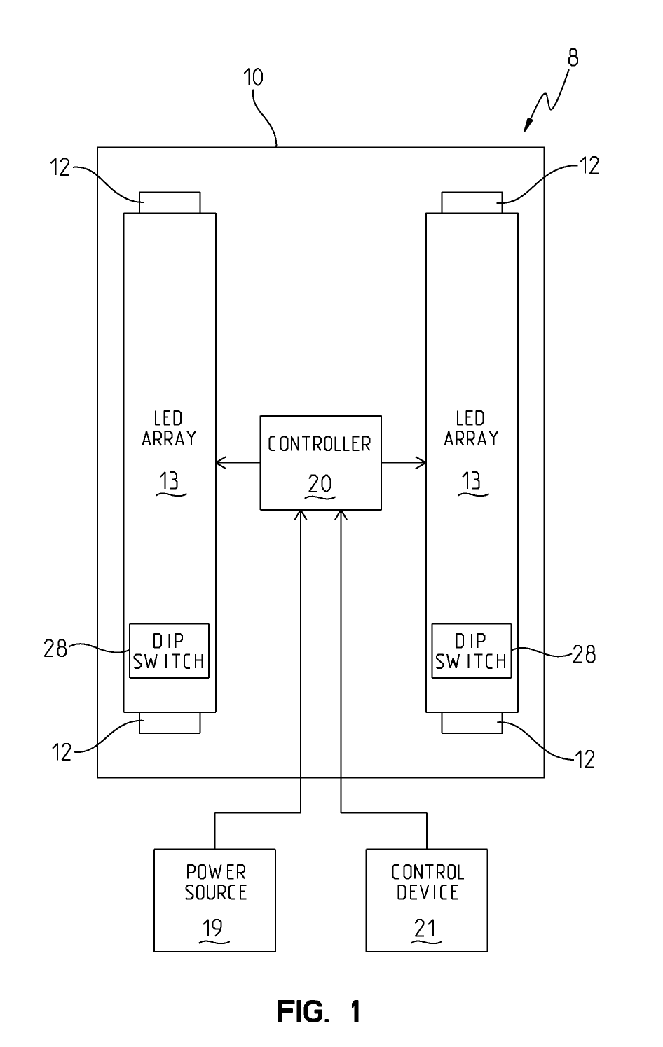

Referring to FIG. 1, an exemplary LED lighting system 8 is shown for retrofitting a conventional fluorescent lighting fixture. LED lighting system 8 includes controller 20 coupled to at least one LED array 13 and mounted in conventional fluorescent fixture or housing unit 10. LED arrays 13 are illustratively coupled to receptors 12 of housing unit 10. Receptors 12 are illustratively existing fluorescent bulb connectors for a conventional fluorescent lighting fixture. Controller 20 is configured to control LED arrays 13 and to selectively provide power from power source 19 to LED arrays 13. Power source 19 is illustratively remote from housing unit 10, but may alternatively be located within or near housing unit 10. Power source 19 is configured to supply 120 Volts Alternating Current (Vac), 277 Vac, or any other suitable power input to controller 20. In one embodiment, controller 20 includes a rectifier configured to convert an alternating current (AC) power source into a direct current (DC) output supplied to LED arrays 13. In some embodiments, LED controller 20 may not be required because of a specific design and/or type of LED arrays 13. In these embodiments, LED arrays 13 may receive power directly from line voltage.

In one embodiment, one or more external control devices 21 optionally may be coupled to controller 20 for providing dimming or on/off commands to LED lighting system 8. Optionally, a 0-10 Volt direct current dimming signal input is capable of sourcing (supplying) or sinking (consuming) current to or from controller 20 respectively. This optional feature of using a 0-10 Volt direct current signal for dimming control fosters compatibility with standard 0-10 Vdc signaling formats. The Source/Sink option in this exemplary embodiment may be controlled via a DIP-switch integral to LED Controller 20, e.g. a dipswitch similar to dipswitch 28 described below. Exemplary control devices 21 may include a light switch external to LED lighting system 8 (such type of external switch not shown), such as a conventional single pole, single throw light switch, a dimmer switch, or any other suitable device which provides control of LED lighting system 8 to a user. In one embodiment, controller 20 is configured to communicate with control device 21 using wireless communication. Control device 21 may transmit control signals to controller 20 over wire lines and/or wireless communication.

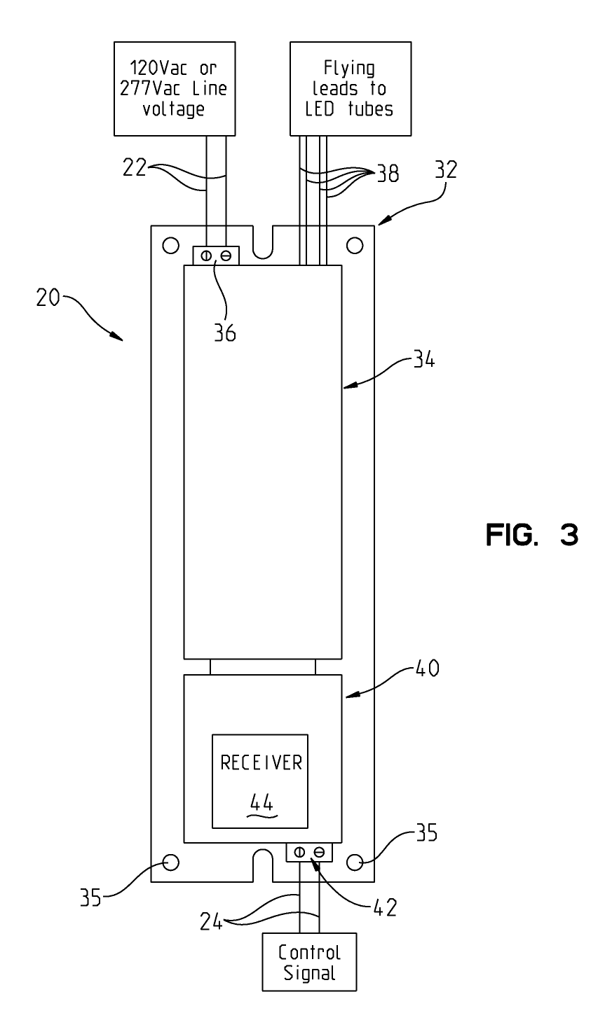

One exemplary embodiment of controller 20 is illustrated in FIG. 3. Referring to FIG. 3, controller 20 consists of LED driver 34 and signal conditioner 40 mounted to mounting base 32. In the exemplary embodiment, signal conditioner 40 is coupled to LED driver 34, but these two devices may alternatively be integrated. Mounting base 32 of controller 20 illustratively is configured and arranged to fit existing ballast mounting points provided in fluorescent housing unit 10. Although controller 20 illustratively controls a single housing unit 10, multiple housing units 10 may be controlled by a single controller 20 depending on the capacity of controller 20 and wiring arrangements of the lighting system. In addition, other numbers of LED arrays 13 may be controlled by controller 20 depending on the capacity of controller 20 and wiring arrangements and/or available wireless communication of the lighting system.

LED driver 34 is configured to rectify and regulate power line voltage received from power source 19 to a level suitable for consumption by LED arrays 13. Signal conditioner 40 is configured to modulate the output power of LED driver 34 and may be locally or remotely mounted. In one embodiment, signal conditioner 40 modulates the power of a plurality of LED drivers 34. Signal conditioner 40 accepts various signals from building automation system (BAS) or lighting system controls to modulate the power of one or more locally or remotely mounted LED drivers 34 and therefore the light output of LED arrays 13. Depending on design configurations, signals accepted by signal conditioner 40 may include 0-10 Volts Direct Current, 0-20 milliAmperes, TRIAC modulated Power Line Voltage, X10 power line, RS485, LONworks, and Radio Frequency communication. RS485 protocols may include but are not limited to BACnet and MODbus. Radio Frequency communication may include but is not limited to Z-wave and Zigbee protocols. Control signals received by signal conditioner 40 may allow a BAS or lighting system to schedule ON and OFF times for LED arrays 13, to dim the LEDs based on schedules, to dim the LEDs based on local light or occupancy sensors, and/or to allow for local overrides of LED lighting system 8. In one embodiment, signal conditioner 40 of controller 20 may not be required depending on the particular design configurations of LED arrays 13. While signal conditioner 40 is illustratively a component of controller 20 and is positioned in housing unit 10, signal conditioner 40 may be a separate component from controller 20 and/or drive one or more LED drivers 34 from a remote location not near LED arrays 13.

Referring to FIG. 1, in one embodiment, LED lighting system 8 may optionally include at least one dipswitch 28. Dipswitch 28 is used to set the dimming level of the particular LED array 13. For example, dipswitch 28 may be an array of single pole, single throw contacts, a rotary type dipswitch, or any other suitable dipswitch. In one embodiment, dipswitch 28 has 4 or 6 positions and is configured to provide various dimming levels to the corresponding LED array 13. By utilizing a dipswitch configuration, each LED array 13 may be individually set to a dimming level appropriate for the installed environment. In one embodiment, LED lighting system 8 includes one dipswitch 28 for controlling the dimming level of each LED array 13. In one embodiment, each LED array 13 includes at least one dipswitch 28. Dipswitch 28 may be mounted on each LED array 13, on housing unit 10, or on any other suitable location of LED lighting system 8.

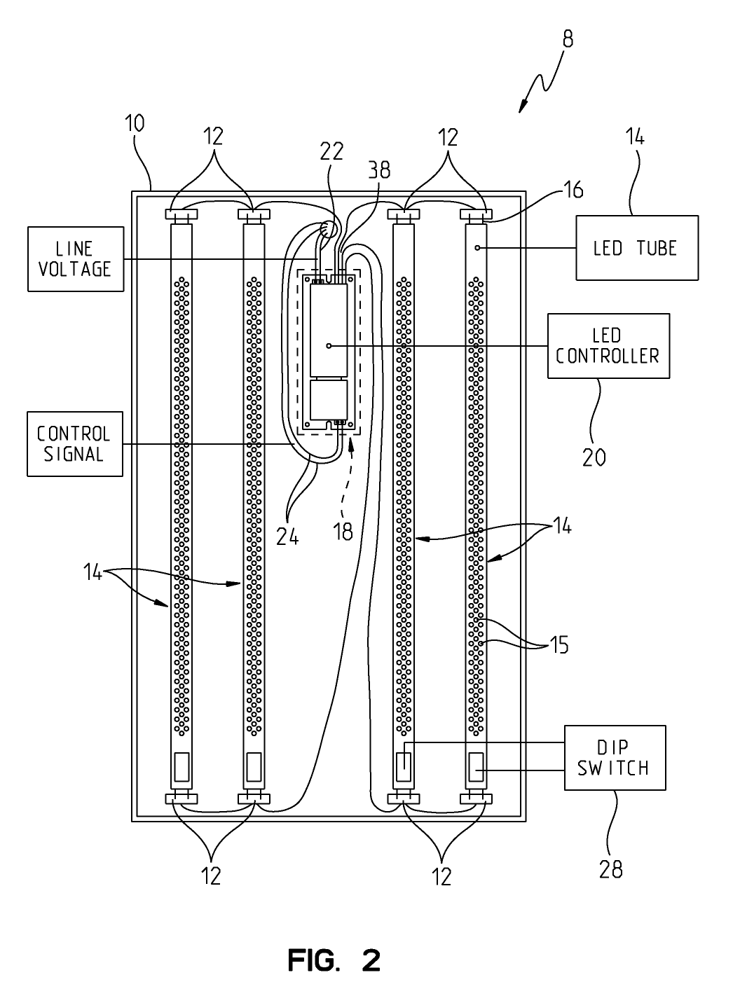

Referring to FIG. 2, one illustrated embodiment of LED lighting system 8 is shown. In FIG. 2, LED arrays 13 of FIG. 1 illustratively include four LED tubes 14, although any desired number of LED tubes 14 may be provided. Each LED tube 14 illustratively includes an elongated body having a plurality of LEDs 15. Receptors 12 of fluorescent housing unit 10 are illustratively bi-pin receptors 12 depicted in a four tube arrangement and configured to receive LED tubes 14. LED tubes 14 have bi-pin contacts 16 adapted to electrically engage receptors 12. LED tubes 14 are sized to replace fluorescent tubes of fluorescent housing unit 10. In one embodiment, LED tubes 14 are externally configured as conventional two inch fluorescent tubes. In one embodiment, LED tubes 14 are four or eight feet in length. LED array tube 14 may optionally incorporate an automatic electronic safety switch (e-switch, not shown) to reduce the risk of electric shock to an installer in the event that a LED tube 14 is mistakenly installed in an electrically live system. The e-switch is activated by sensing voltage between one of the two bi-pin contacts 16 at each end of LED tube 14. The remaining bi-pin 16 at each end of tube 14 conducts electrical power only after voltage sense pins have detected voltage. Such voltage sense pins of the e-switch, in the exemplary embodiment, draw less than seven microAmpres (7 mA) through five hundred Ohms (500Ω) of resistance.

Controller 20 is configured to drive each LED tube 14. As illustrated in FIG. 2, controller 20 is mounted over ballast location 18. Ballast location 18 is illustratively an area of fluorescent housing unit 10 where conventional electric ballasts are mounted to support fluorescent lighting requirements. As illustrated in FIG. 3, controller 20 illustratively includes mounting base 32 having a configuration which conforms to existing fluorescent ballast form factors. For example, screw holes 35 arranged on mounting base 32 are configured to align with corresponding screw holes (not shown) in ballast location 18. While the exemplary embodiment shows a lighting configuration for four LED tubes 14, other numbers of LED tubes 14 may be accommodated by controller 20.

Power lines 22 are coupled to input terminals 36 of LED driver 34 to provide power to controller 20 and allow controller 20 to drive LED tubes 14. Exemplary input terminals 36 may include screw terminals or push-in connectors. In one embodiment, power lines 22 are routed to controller 20 from power source 19 (see FIG. 1) and provide 120 Volts Alternating Current (Vac), 277 Vac, or any other suitable electric power input to controller 20. LED driver 34 further includes flying leads 38 connected to receptors 12 and configured to provide power from LED driver 34 to LED tubes 14. Receptors 12 are configured to communicate the power received from leads 38 to LED tubes 14. In one embodiment, leads 38 may bypass receptors 12 and may be coupled directly to LED tubes 14 for providing power to LED tubes 14.

In one embodiment, one or more communication lines 24 are routed between controller 20 and control device 21 of FIG. 1. Communication lines 24 are configured to provide control signals to controller 20, such as to provide on/off commands or dimming controls. As illustrated in FIG. 3, signal conditioner 40 has input terminals 42, for example screw terminals or push-in connectors, for receiving control signals via communication lines 24. Signal conditioner 40 is adapted to receive control signals using one or more of the following signal types/protocols: 0-10V, 0-20 mA, TRIAC, RS485, BACnet, LONworks, PWM, Pulse, Tri-state, Zwave, X10, or other specified scheme or standard. Signal conditioner 40 may also include receiver 44 for receiving telecommunications signals in one or several formats, including wireless communication. One signal conditioner 40 may be configured to drive one or more LED drivers 34.

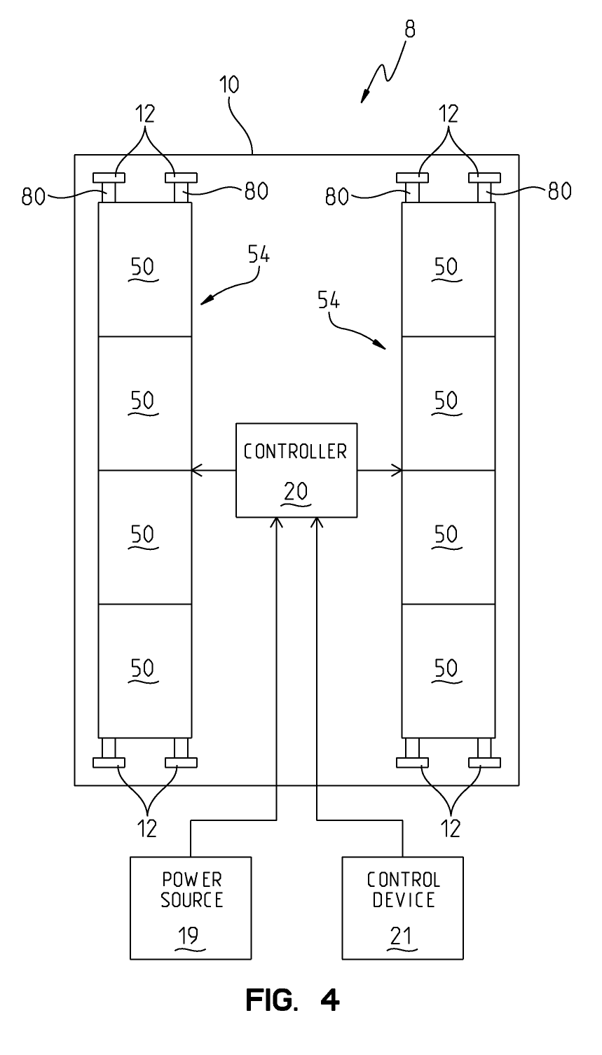

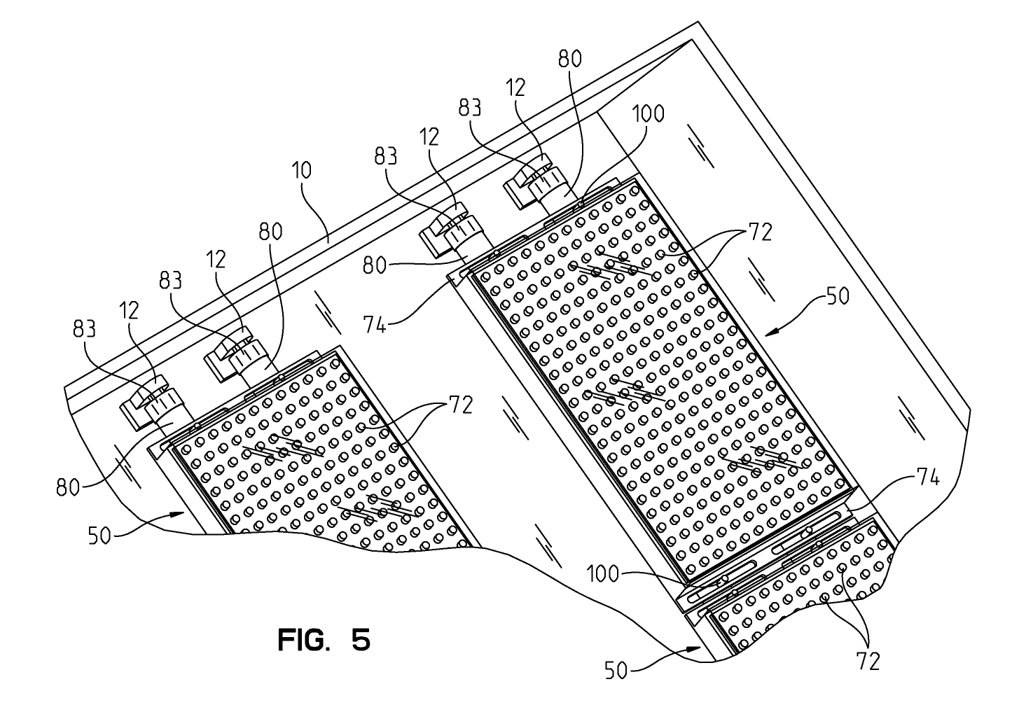

Referring to FIGS. 4-9, another illustrated embodiment of LED lighting system 8 of FIG. 1 is shown. In FIG. 4, LED arrays 13 of FIG. 1 illustratively include eight LED panels 50 in panel array 54. In particular, panel array 54 of FIG. 4 consists of two rows of four LED panels 50, each row arranged along the length of fluorescent housing unit 10. However, any desired number or arrangement of LED panels 50 may be provided depending on the design and capacity of housing unit 10, LED panels 50, and controller 20. Mounting brackets or tubes 80, shown in FIG. 5, are coupled to receptors 12 of fluorescent housing unit to provide a mounting location for LED panels 50. In one embodiment, fluorescent housing unit 10 is configured as a typical dimension for drop ceiling “troffer” applications. In one embodiment, an existing diffuser or cover on fluorescent housing unit 10 is used to aid light distribution. Various embodiments may accommodate various sizes of fluorescent housing units 10 so that the arrangement, size, and number of LED panels 50 may vary to allow for a maximum mounting area for panel array 54. A large mounting area for panel array 54 provides a high overall LED count resulting in light output that is competitive in strength with the light output of existing fluorescent lamps.

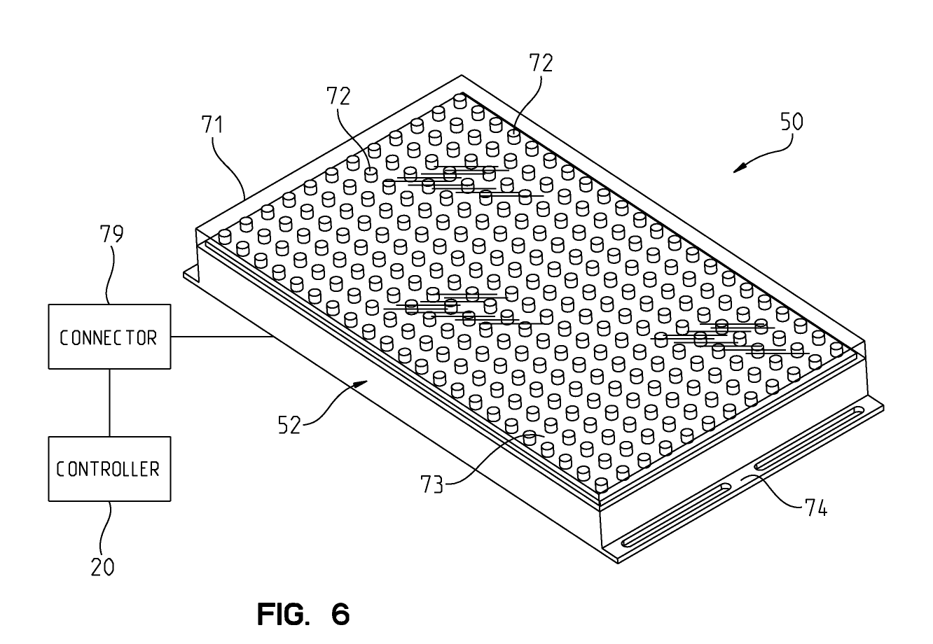

Depending on the configuration, LED panels 50 of FIG. 4 may receive regulated power from controller 20 or power directly from line voltage. Controller 20 of FIGS. 1-3 is illustratively included in the embodiment of FIG. 4 and includes LED driver 34 and signal conditioner 40. As with the embodiment of FIG. 2, LED driver 34 is configured to rectify and regulate line voltage to a suitable level for powering LED panels 50, and signal conditioner 40 is configured to modulate the output power of LED driver 34. Leads 38 (see FIG. 3) of LED driver 34 are configured to provide power from LED driver 34 to LED panels 50. In the illustrated embodiment, no electrical connection is made between receptors 12 and end caps 83 of mounting tube 80. As such, leads 38 are routed directly to LED panels 50, bypassing receptors 12, and are configured to connect to connectors 79 (see FIG. 6) of LED panels 50. Accordingly, receptors 12 provide a mechanical connection for securing mounting tube 80 to housing unit 10.

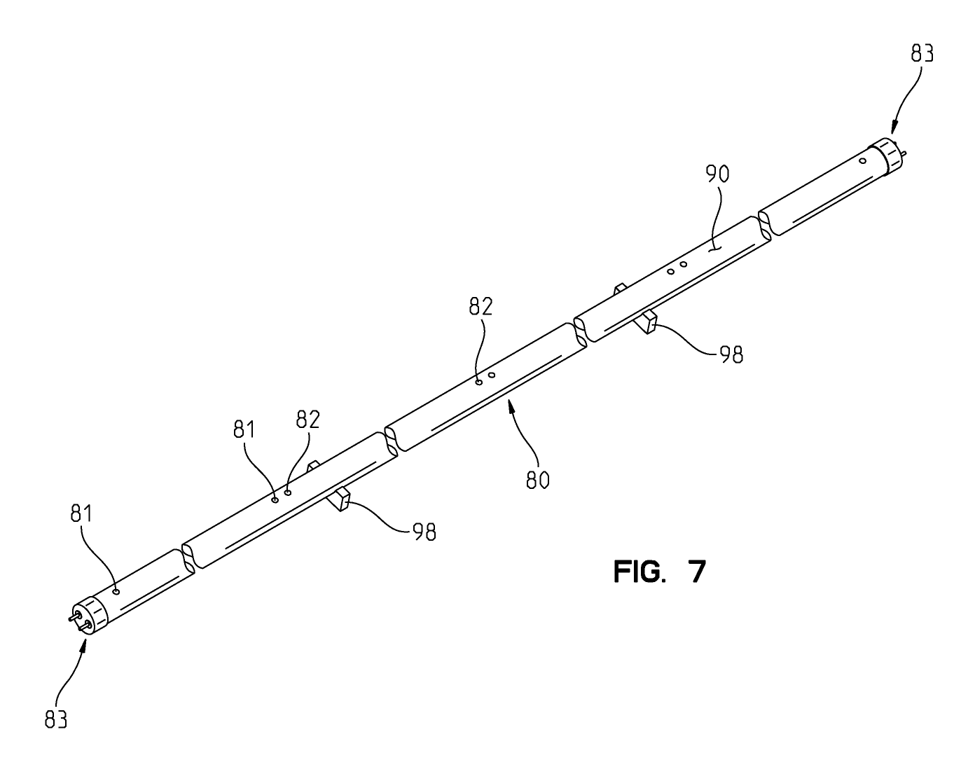

Alternatively, leads 38 may be routed to receptors 12, and an electrical connection may be provided between receptors 12 and bi-pin end cap 83. As such, mounting tube 80 may have one or more electrical wires or connectors (not shown in FIG. 7) along its surface routed between end cap 83 and connectors 79 to provide power and/or control signal connections to LED panels 50.

Each LED panel 50 may consist of various elements. Referring to FIG. 6, in one embodiment, each LED panel 50 includes a transparent plastic lens 71, a printed circuit board assembly (PCBA) 73 or other electrical mounting system assembled with an array of LEDs 72, an enclosure back 52, and one or more electrical connections or connectors 79 which communicate power from controller 20 to PCBA 73 and LEDs 72. Electrical connectors 79 are coupled to any suitable location of enclosure back 52 to facilitate quick assembly of panel array 54. In one embodiment, electrical connectors 79 provide a quick electrical disconnect on line powered LED panels 50 to conform to state and federal regulations.

PCBA 73 comprises a plurality of LEDs 72 mounted to a printed circuit board. The quantity of LEDs 72 in PCBA 73 may be varied to accommodate LEDs 72 with higher or lower luminous output. LEDs 72 in one exemplary embodiment are white, although any color or configuration of LEDs 72 may be accommodated. A current limiting device and/or rectifier (not shown) may be included in PCBA 73 to respectively limit or rectify the current supplied to LEDs 72. LEDs 72 may be electrically connected in parallel, series (strings), or combination series parallel circuits. Lens 71 provides protection to LEDs 72 and may have a molded pattern to aid in light distribution.

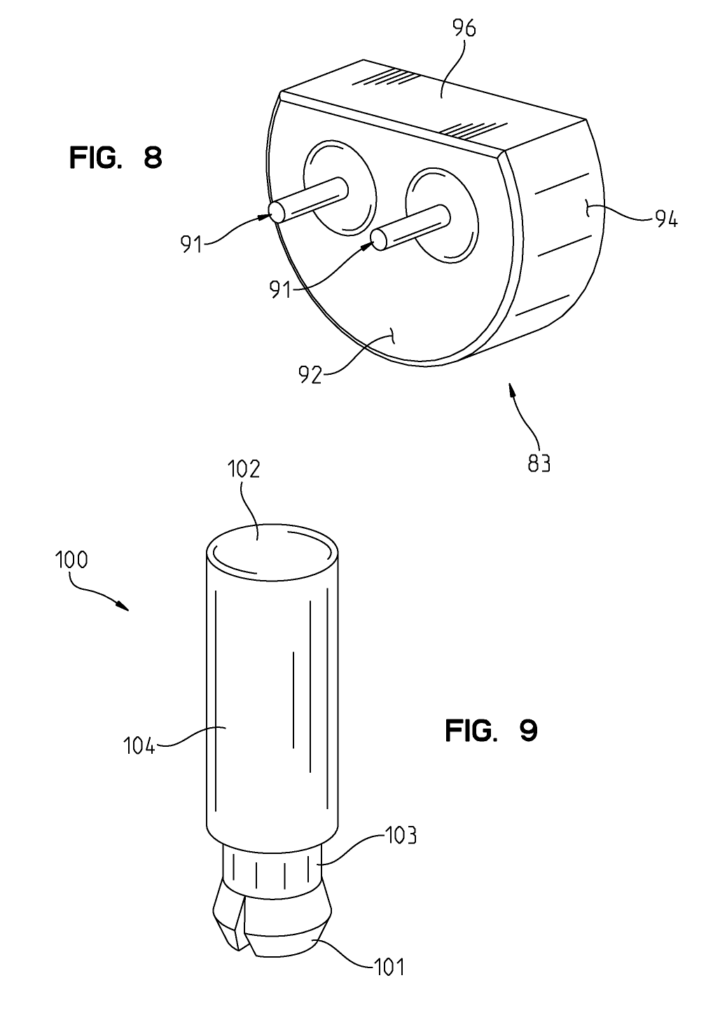

As shown in FIGS. 7 and 7a, mounting bracket or tube 80 has a plurality of mounting holes pairs, including holes pair 81 and holes pair 82, each for receiving push-in fasteners 100 (see FIGS. 5 and 9). In the illustrated embodiment, mounting tube 80 comprises an elongated hollow cylinder with mounting holes 81, 82 spaced in an axial line on surface 90. Mounting holes 81, 82 are spaced to coincide with mounting points such as slotted flanges 74 on LED panels 70. Each mounting tube 80, in this exemplary embodiment, has one bi-pin end cap 83 mounted at each end of tube 80. Mounting tube 80 illustratively has a circular cross-section in FIG. 7. In one embodiment, mounting tube 80 has a half moon or “D” shaped cross-section to provide a flat surface 97 for mounting LED panels 50, as illustrated in FIG. 7a. Mounting tube 80 may alternatively have other design configurations suitable for mounting LED panels 50 to housing unit 10.

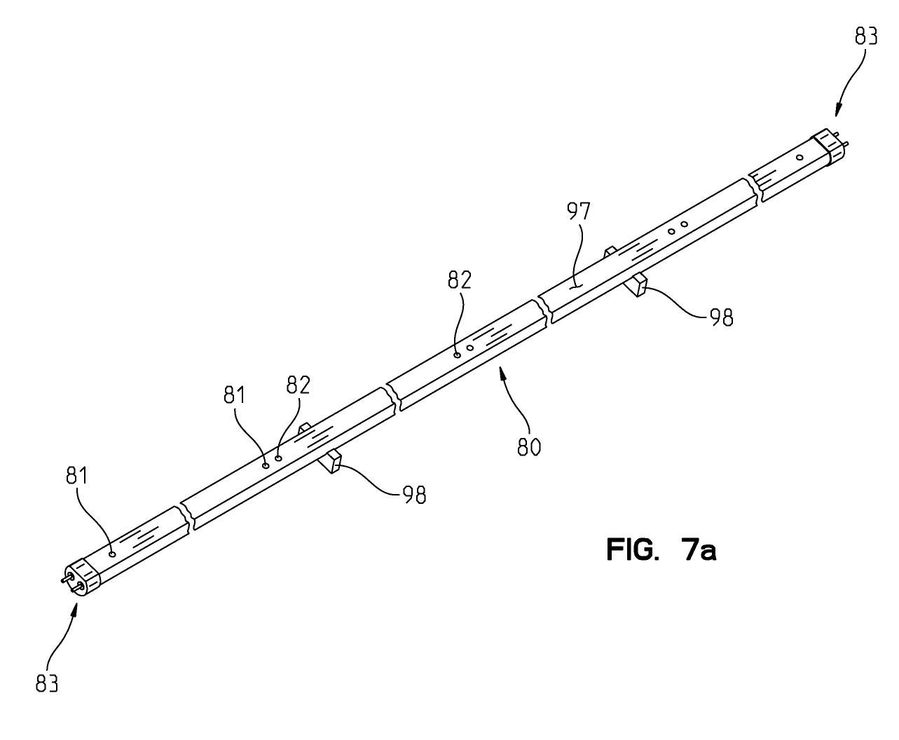

As illustrated in FIG. 8, end cap 83 of mounting tube 80 includes two pins 91 extending from surface 92. Surface 94 of end cap 83 is at least partially cylindrical to coincide with cylindrical surface 90 of tube 80. In the illustrated embodiment of FIG. 8, surface 94 of end cap 83 includes a flat portion 96 and is configured to coincide with “D” shaped mounting tube 80 illustrated in FIG. 7a. End cap 83 may alternatively have a substantially cylindrical cross-section, such as end cap 83 illustrated in FIG. 7. Bi-pin end cap 83 is configured to provide a mechanical connection between tubes 80 and bi-pin receivers, illustratively receptors 12, of fluorescent housing unit 10. Other suitable designs for end cap 83 may be provided for tubes 80 engaging single pin fluorescent tube connectors on fluorescent housing unit 10, such as spring loaded single pin fluorescent tube connectors. In the illustrated embodiment, mounting holes 81, 82 of tube 80 are arranged about 90° from the plane of pins 91 of end caps 83, although other arrangements may be provided.

FIG. 9 depicts one embodiment of push-in fastener 100, which is employed to secure the mechanical connection between mounting tube 80 and LED panel 50, as illustrated in FIG. 5. Push-in fastener 100 includes rod portion 104 extending between stub end 102 and holding portion 103. Holding portion 103 includes expandable hub 101 at the end of fastener 100 opposite of stub end 102 configured to secure fastener 100 to LED panel 50.

Referring to FIG. 5, enclosure back 52 of LED panel 50 provides a common physical connection point for mounting tubes 80, PCBA 73, lens 71, and LED driver 34. Slotted flanges 74 of enclosure back 52 are provided as a mounting point between push-in fasteners 100 and mounting tube 80. Each of holes 81, 82 fixedly receives stub end 102 of push-in fasteners 100 so that expandable hub 101 may extend through one of slotted flanges 74 and retain the associated LED panel 50. Enclosure back 52 of LED panel 50 is spaced from mounting tube 80 by rod portion 104 which prevents slotted flanges 74 from progressing beyond holding portion 103 towards mounting tube 80. Push-in fasteners 100 may be pressed into holes 81, 82 of mounting tube 80 through an interference fit, by adhesive, by sonic welding, or other appropriate physical connection. Push-in fasteners may alternatively be molded as an integral part of enclosure back 52 of LED panel 50, and thus engage holes 81, 82. Alternatively, other fasteners such as hooks, magnets, or screws may be used to secure LED panels 50 to mounting tubes 80. In one embodiment, mounting tube 80 is integrated with LED panels 50, obviating the need for fasteners to attach LED panels 50 to mounting tube 80.

In one embodiment, a brace or bracket 98 sized to fit between mounting tube 80 and fluorescent housing unit 10 may be provided to prevent the flexing of tube 80 during installation of LED Panel 50, as illustrated in FIG. 7. Bracket 98 may be mounted to housing unit 10 or to mounting tube 80 or to both housing unit 10 and mounting tube 80.

In one embodiment, mounting tube 80 may have an adjustable length to allow for the rotation of the angle of bi-pin end cap 83 in relation to mounting holes 81, 82. During installation of preassembled LED panels 50 and mounting tubes 80, an adjustable length of tube 80 allows for clearance of LED panels 50 and tube 80 through the dimensions of fluorescent housing unit 10 and for insertion of tube 80 into receptors 12. In one embodiment, tubes 80 may be manufactured in regularly sized sections to allow for ease of manufacturing and assembly. Alternatively, sectional mounting tube design may be used to provide snap or threaded mechanical connections for assembly of multiple sections.

In one embodiment, the embodiments of LED lighting system 8 described herein include enhanced dimming control and functionality for dimming LED arrays 13. Dimming capabilities may be provided in various ways. In one embodiment, dimming may be set by setting dipswitch 28 (see FIG. 1) of LED lighting system 8 to designate a predetermined dimming level. In another embodiment, controller 20 is programmed to recognize the repeated switching of a power source as an indication of the level of dimming desired.

In one embodiment, LED lighting system 8 includes at least one dipswitch 28, as illustrated in FIG. 1. In one embodiment, each LED tube 14 (FIG. 2) or each LED panel 50 (FIG. 4) may include at least one dipswitch 28. Dipswitch 28 is used to set the dimming level of at least one LED array 13. Dipswitch 28 is connected between the output of LED driver 34 and the LEDs of a particular LED array 13 to control the amount of current that reaches the LEDs of LED array 13. Dipswitch 28 may be an array of single pole, single throw contacts, a rotary type dipswitch, or any other suitable dipswitch. In one embodiment, dipswitch 28 has 4 or 6 positions or switches and is configured to provide various dimming levels to the corresponding LED array 13 based on the setting of each position or switch. By utilizing a dipswitch configuration, each LED array 13, in particular each LED tube 14 or each LED panel 50, may be individually set to a dimming level appropriate for the installed environment, and a standard LED tube 14 or LED panel 50 may be installed in a variety of environments. In another embodiment, a single dipswitch 28 may be configured to collectively adjust the dimming level of each LED array 13. Although not shown, LED panels 50 may also optionally include a dipswitch for preconfigured dimming levels in the same manner as LED tubes 14.

Dimming capabilities may also be achieved by varying the duty cycle of a Pulse Width Modulated (PWM) control signal and thereby the average power transmitted to the LED lighting system 8. In particular, controller 20 may be programmed to recognize the repeated switching of a power source as an indication of the level of dimming desired. In one embodiment, control device 21 of FIG. 1 includes a standard light switch configured to turn on and off LED lighting system 8. Toggling the light switch results in rapid power application and power loss to controller 20 and/or LED arrays 13. Controller 20 may adjust the power provided to each LED array 13 according to the specific cadence of the light switch toggling or “duty cycle” of the PWM control signal received by controller 20, thereby adjusting the light output of the LEDs of system 8. In one embodiment, signal conditioner 40 of controller 20 detects the rapid power application and power loss (i.e. the light switch being toggled) and dims the LEDs based on the number of times the light switch is toggled.

In one embodiment, dipswitch 28 is utilized in conjunction with the toggling of the light switch to achieve dimming capabilities. As such, a standard light switch may be used to selectively dim a switched LED light system with the initial dim level being determined by the set position of dipswitch 28. Any of the embodiments described herein may be used with dipswitch 28 for setting a dim level and/or with signal conditioner 40 that recognizes the quick switching of a power source as a dim control signal.

Dimming capabilities may alternatively be controlled by other telecommunication including wired, infrared, and radio frequency communication between control device 21 and controller 20. In one embodiment, control device 21 may include a dimmer switch configured to adjust the power received by LED arrays 13. In another embodiment, dimming may be achieved by removing power from specific LEDs or LED strings of LED array 13. In such a design, LED driver 34 of controller 20 may incorporate active or passive methods of power factor correction and harmonic distortion limiting to achieve dimming capabilities.

LED lighting system 8 may further include light level sensors configured to detect the level of light in the surrounding space. Such sensors may be used to control the light output of LED arrays 13, such as turning on/off or dimming the LED arrays 13 depending on the amount of light detected by the sensors. In one embodiment, passive infrared (PIR) sensors are used to detect the level of infrared light radiating from objects in the field of view of the PIR sensors. The on/off state or dimming level of LED arrays 13 may be controlled based on the detected level of infrared light by the PIR sensors.

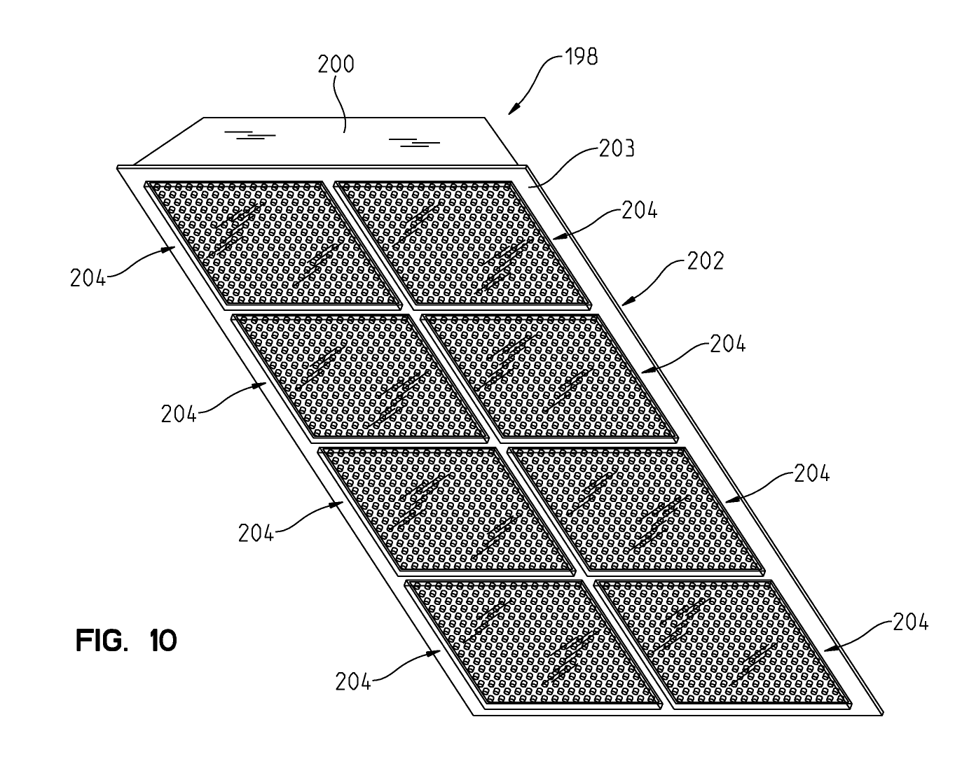

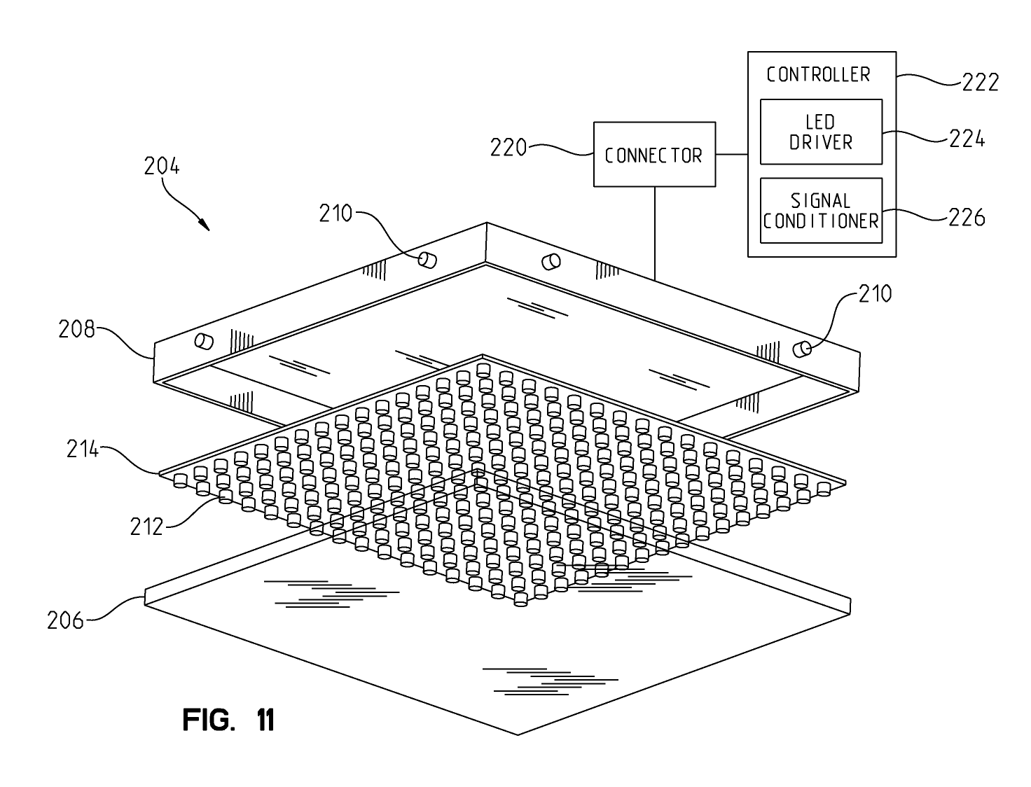

FIGS. 10 and 11 illustrate an LED panel system 198 adapted for a fluorescent fixture retrofit application. LED panel system 198 illustratively replaces the ballast(s), the fluorescent tubes, and the light diffuser assembly of a conventional fluorescent system in standard drop ceiling “troffer” fluorescent lighting fixtures. In one embodiment, LED panel system 198 may be configured for installation in an existing fluorescent lighting fixture in place of the diffuser of the fluorescent lighting fixture. In one embodiment, LED panel system 198 may be designed as a stand-alone, complete lighting fixture solution for direct installation in common drop ceiling openings, thereby negating the need for an existing fluorescent lighting fixture. In this embodiment, LED panel system 198 may include a larger size frame and/or an adapter for a single design frame to allow LED panel system 198 to fit into a standard drop ceiling opening without having to mount system 198 to an existing fluorescent lighting fixture. Such a retrofit/complete fixture design of LED panel system 198 may allow common parts of system 198 to be manufactured in bulk, thereby reducing part cost.

LED panel system 198 illustratively includes LED array 202 coupled to mounting frame or housing 200. LED panel system 198 provides a large mounting area for LED array 202 to allow a high overall LED count. This high LED count results in light output that is competitive in strength with the light output of existing fluorescent lamps. LED array 202 includes frame 203 having openings sized to accommodate LED panels 204. In one embodiment, frame 203 may be plastic or metallic. LED array 202 illustratively includes eight LED panels 204 configured in a 2×4 arrangement, but the arrangement, size, and number of panels may vary to allow the maximum mounting area for LED array 202 and to provide mechanical stability. For example, the principals of this embodiment may also be instantiated in 1×4, 2×2, and other suitably sized fixtures.

LED panels 204 illustratively receive electrical power regulated by a remote or local controller 222, shown in FIG. 11. In one embodiment, controller 222 includes LED driver 224 and signal conditioner 226. LED driver 224 is configured to rectify and regulate line voltage to a level acceptable for powering LED panels 204 of LED array 202. Signal conditioner 226 is configured to modulate the output power of LED driver 224. In one embodiment, signal conditioner 226 is optional depending on the design configuration of LED array 202 and the need for modulating the output power of LED driver 224. In one embodiment, controller 222 is mounted within mounting frame 200 of LED panel system 198, but controller 222 may alternatively be external to mounting frame 200. In an embodiment where LED panel system 198 utilizes an existing fluorescent fixture, controller 222 may be designed to fit the ballast mounting points provided in common fluorescent fixtures. Alternatively, controller 222 may be excluded from LED panel system 198, and LED panels 204 may receive raw electrical power from line voltage. In one embodiment, controller 20 of FIGS. 1-4 may be implemented as controller 222.

Signal conditioner 226 may accept various control signals from building (automation) controls to modulate the power of locally or remotely mounted LED driver 224 and therefore the light output of LED panels 204. Depending on design configuration, signals accepted by signal conditioner 226 may include 0-10 Volts Direct Current, 0-20 milliAmperes, TRIAC modulated power line voltage, X10, RS485, LONworks, and Radio Frequency communication. RS485 protocols may include but are not limited to BACnet and MODbus. Radio Frequency communication may include but is not limited to Z-wave and Zigbee protocols. In one embodiment, control device 21 (see FIG. 1) is coupled to signal conditioner 226 to provide dimming or on/off commands to LED panel system 198.

In an exemplary embodiment shown in FIG. 11, each LED panel 204 includes a transparent plastic lens 206, a printed circuit board assembly (PCBA) 214 or other electrical mounting system assembled with an array of LEDs 212, an enclosure back 208, and an electrical connection or connector 220. As shown in FIG. 11, connector 220 is configured to electrically connect to controller 222 to communicate power, dimming or other control signals between LED driver 224, PCBA 214, and LEDs 212. Connector 220 may be situated anywhere on enclosure back 208 to facilitate quick assembly of LED panel system 198. In one embodiment, connector 220 provides a quick electrical disconnect on line powered LED panels 204 to conform to state and federal regulations.

PCBA 214 comprises a plurality of LEDs 212 mounted to a printed circuit board. The quantity of LEDs 212 in the PCBA 214 may vary depending on the luminous output of LEDs 212. In one embodiment, LEDs 212 are white and uniformly spaced on PCBA 214, although any color or configuration of LEDs 212 may be accommodated. A current limiting device and/or rectifier (not shown in FIG. 11) may be included in PCBA 214 to respectively limit or rectify the current supplied to LEDs 212. LEDs 212 may be electrically connected in parallel, series (strings), or a combination series/parallel circuit. Lens 206 provides protection to LEDs 212 and may have a molded pattern to aid in light distribution.

Enclosure back 208 provides a common physical connection point for frame 203 of LED array 202, PCBA 214, lens 206, and LED driver 224 of controller 222. Cylindrical protrusions 210 are molded along the edges of enclosure back 208 to serve as a mounting point between LED panel 204 and frame 203 of LED array 202. In one embodiment, snap mount points (not shown) are provided in the interior edges of frame 203 to allow secure mechanical connections between frame 203 and cylindrical protrusions 210. Other fasteners such as screw eyelets, hooks, magnets, and/or screws may alternatively be used to secure LED panels 204 to frame 203. In one embodiment, mounting points for controller 222 and/or an electrical connection box may be molded into enclosure back 208.

In one embodiment, LED panel system 198 may include stationary or spring loaded hinge bolts (not shown) located on an outer edge of frame 203. These bolts provide a pivoting mechanical connection between LED array 202 and mounting frame 200 that allows LED array 202 to open, thereby exposing the interior of LED panel system 198 to allow access to the internal wiring and controls. In one embodiment, magnets (not shown) secured to an edge of frame 203 of array 202 may be used in place of or to supplement the hinge bolts. In one embodiment, magnets are positioned on at least an outer edge of frame 203 opposite the hinge bolts. Alternatively, other suitable fasteners may be provided to supplement the hinge bolts.

In one embodiment, one or more belts (not shown) may be attached near an outer edge of frame 203 of LED array 202, particularly along one of the long outer edges, which may also supplement the hinge bolts. Such belts attach to mounting frame 200 via screw connections or spring loaded clasps configured to fit mounting holes that are included in conventional fluorescent lighting fixtures. The position of the belts along the length of frame 203 of LED array 202 may be adjustable to accommodate varying shapes and sizes of LED array 202 and/or belts. In one embodiment, one or more mechanical clasps (not shown) may also be integrated with frame 203 of array 202 along one of the outer edges (opposite of aforementioned belt system) to engage the mounting holes commonly found on conventional fluorescent lighting fixtures. The position of the clasps along the length of frame 203 may be adjustable to fit various designs and configurations of LED panel system 198. In one embodiment, frame 203 of LED array 202 may be configured to vary in length or width to allow for proper fit of LED array 202 in fluorescent lighting fixtures of different designs and configurations.

Controller 222 may also provide dimming capabilities according to a specific cadence of light switch toggling, as discussed above with respect to controller 20. Dimming capabilities of LED panel system 198 may also be controlled by other means of telecommunication including wired, infrared and radio frequency. In one embodiment, dimming is achieved by varying the duty cycle of a Pulse Width Modulated (PWM) control signal and thereby the average power transmitted to the LED panel 204. Dimming may also be achieved by removing power from specific LEDs 212 or LED strings of LED array 202. Such a design may incorporate active or passive methods of power factor correction and harmonic distortion limiting.

As discussed above with respect to controller 20, signal conditioner 226 of controller 222 may detect rapid power application and power loss (for example, a switch being turned off and on rapidly) which, for example, allows signal conditioner 226 to dim LEDs 212 based on the number of times a conventional light switch is toggled. The light switch may be used in conjunction with a dimmer dipswitch, such as dipswitch 28, to selectively dim LED panel system 198 with the initial dim level being determined by the set position of the dipswitch.

In one embodiment of the present disclosure, a lighting kit adapted for installation into a conventional fluorescent lighting unit having a fluorescent socket, a ballast disposed in the lighting unit, and a power supply attached to the lighting kit is provided. The lighting kit comprises at least one elongated body having fixture ends, each of said fixture ends configured to engage a fluorescent socket. The elongated body supports a plurality of light emitting diodes (LEDs). The lighting kit further comprises a control unit adapted to electrically connect the fluorescent sockets to a power source and adapted to be mounted in place of the ballast. The lighting kit may further comprise circuitry for dimming said plurality of LEDs based on repeated switching of a power switch. The elongated body may further support a dipswitch, and the lighting kit may further comprise circuitry for dimming the plurality of LEDs based on the setting of the dipswitch. The elongated body may include a mounting bracket adapted to attach to a LED panel. The fixture ends may include a bi-pin configuration. The body may be generally cylindrical. The control unit may be capable of receiving exterior control signals and capable of operating the LEDs based on received control signals. The control unit may be adapted to receive control signals remotely over a wire line and/or a wireless communication.

While this invention has been described as having an exemplary design, the present invention may be further modified within the spirit and scope of this disclosure. This application is therefore intended to cover any variations, uses, or adaptations of the invention using its general principles. Further, this application is intended to cover such departures from the present disclosure as come within known or customary practice in the art to which this invention pertains.

What is claimed is:

1. A lighting kit adapted for installation into a conventional fluorescent lighting unit having a fluorescent socket, a ballast disposed in the lighting unit, and a power supply coupled to the lighting unit, the lighting kit comprising:
at least one elongated body having fixture ends, each of said fixture ends configured to engage a fluorescent socket, said elongated body supporting a plurality of light emitting diodes (LEDs);
a control unit adapted to electrically connect the fluorescent sockets to a power source, said control unit adapted to be mounted in place of the ballast; and
means for dimming said plurality of LEDs based on repeated switching of a power switch, said means for dimming operating according to a 0-10V control signal.

2. The lighting kit of claim 1, wherein said fixture ends include a bi-pin configuration having a switch activated by sensing voltage.

3. The lighting kit of claim 1, further comprising at least one LED panel, wherein said elongated body includes a mounting bracket adapted to attach to said at least one LED panel.

4. The lighting kit of claim 1, further comprising at least one LED panel, wherein said body is generally cylindrical having an elongated flat section for mating with said at least one LED panel.

5. The lighting kit of claim 1, wherein said control unit is configured to receive exterior control signals and to operate said LEDs based on said received control signals.

6. The lighting kit of claim 5, wherein said control unit includes a signal conditioner for receiving said control signals and a driver for providing power to said LEDs, said signal conditioner adapted to modulate the power provided by said driver.

7. The lighting kit of claim 5, wherein said control unit is adapted to receive control signals remotely over at least one of a wire line and a wireless communication.

8. The lighting kit of claim 5, wherein the repeated switching of the power switch generates a pulsed control signal receivable by said control unit, said control unit selectively dimming said LEDs based on the cadence of said pulsed control signal.

9. A lighting kit adapted for installation into a conventional fluorescent lighting unit having a fluorescent socket, a ballast disposed in the lighting unit, and a power supply coupled to the lighting unit, the lighting kit comprising:
at least one elongated body having fixture ends, each of said fixture ends configured to engage a fluorescent socket, said elongated body supporting a plurality of light emitting diodes (LEDs) and a dipswitch;
a control unit adapted to electrically connect the fluorescent sockets to a power source, said control unit adapted to be mounted in place of the ballast; and
means for dimming said plurality of LEDs based on the setting of said dipswitch, said means for dimming operating according to a 0-10V control signal.

10. The lighting kit of claim 9, wherein said fixture ends include a bi-pin configuration having a switch activated by sensing voltage.

11. The lighting kit of claim 9, further comprising at least one LED panel, wherein said elongated body includes a mounting bracket adapted to attach to said at least one LED panel.

12. The lighting kit of claim 9, further comprising at least one LED panel, wherein said body is generally cylindrical having an elongated flat section for mating with said at least one LED panel.

13. The lighting kit of claim 9, wherein said control unit is configured to receive exterior control signals and to operate said LEDs based on said received control signals.

14. The lighting kit of claim 13, wherein said control unit includes a signal conditioner for receiving said control signals and a driver for providing power to said LEDs, said signal conditioner adapted to modulate the power provided by said driver.

15. The lighting kit of claim 13, wherein said control unit is adapted to receive control signals remotely over a wire line and/or a wireless communication.

16. The lighting kit of claim 9, wherein said dipswitch is wired between said control unit and said LEDs.

17. A method of retrofitting a fluorescent housing unit comprising the steps of:
installing a mounting bracket in the fluorescent housing unit;
attaching a plurality of LEDs to the mounting bracket; and
mounting a LED controller in the location configured for receiving a conventional fluorescent ballast, wherein the LED controller operates according to a 0-10V control signal.

18. The method of claim 17, further comprising the step of configuring the LED controller to dim the plurality of LEDs based on repeated switching of a power switch.

19. The method of claim 17, further comprising the steps of installing a dipswitch in the fluorescent housing unit and configuring the dipswitch to set a dimming level for the plurality of LEDs.

20. The method of claim 17, wherein the attaching step includes fastening at least one LED panel to an elongated flat section of the mounting bracket.

21. The method of claim 20, further comprising the step of providing an electrical connector between the at least one LED panel and the LED controller.
